(19) United States
(12) Patent Application Publication
(10) Pub. No.: US 2002/0087880 A1
(43) Pub. Date: Jul. 4, 2002

(54) Secure gateway multiple automated data storage system sharing

(75) Inventor: John S. Rhoades, St. Peters, MO (US)

Correspondence Address: Wayne P. Bailey, Storage Technology Corporation, One StorageTek Drive, Louisville, CO, 80028-4309, US

(73) Assignee: Storage Technology Corporation

(21) Appl. No.: 09/751,720

(22) Filed: Dec. 29, 2000

(51) Int. Cl. G06F 12/16

(52) U.S. Cl. 713/201

(57) ABSTRACT

A secure gateway multiple automated data storage system sharing is provided. Data is transmitted from a first data storage unit within a first automated data storage system to a second data storage unit. A request is then received from a second data storage system for the second data storage unit. The second data storage unit is then transported to the second data storage system.

### BACKGROUND OF THE INVENTION

1. Technical Field

The present invention relates generally to electronic media storage and retrieval and in particular to an improved method and apparatus for automating the movement of data storage units from one automated data storage system to another.

2. Description of Related Art

Storage library systems are capable of storing and rapidly retrieving large quantities of information stored in storage media cartridges. Such storage library systems often use robotic mechanisms to improve the speed of information retrieval and reliability of maintaining the storage library cartridge inventory.

An automatic cartridge library is a system used for handling large amounts of information in a data processing system. These types of systems store and manage large numbers of standardized cassettes containing magnetic tape on which data is recorded. Typically, an automated cartridge library is comprised of arrays of uniquely identified cells in which each cell contains a single tape cartridge. These cells are arranged in arrays or racks for holding many of these cartridges. Each cartridge has identifying information, such as, for example, a bar code. A robotic arm, having an optical system for selecting the correct cartridge, is operable within the automated cartridge library to locate a particular cell, retrieve a tape cartridge from the cell, convey the tape cartridge to a tape drive, and insert the tape cartridge into a tape drive.

For years now magnetic tape cartridges have proven to be an efficient and effective medium for data storage, including backing up data from primary storage devices and acting as primary storage devices for infrequently accessed data. A tape cartridge is a housing containing magnetic tape. The tape cartridge, which is also referred to as a “tape”, may be wound onto one or more reels within the housing.

Large computer systems have a need to access numerous cartridges. To this end, automated cartridge handling systems or libraries for cartridges have been developed for making the cartridges automatically available to the computer. Many of these automated libraries resemble jukeboxes. These automated libraries are also referred to as “automated cartridge systems” and may contain thousands of cartridges within a single automated cartridge system. The cartridges within an automated cartridge system are accessed using automated or robotic systems. In some systems, a robotic arm moves around within a housing containing cartridges stored in array holders or slots and moves the cartridges. The robotic arm is used to move a cartridge from the array to a tape drive. The robotic arm also is used to remove a cartridge from a tape drive and place the cartridge back into the array. These automated libraries also include automated mechanisms to introduce and remove tape cartridges from the library.

Automated data storage library systems provide a means for large quantities of information to be efficiently stored and retrieved by external systems. These systems generally include one or more robotic units that move data storage media to and from read/write devices where the information can be accessed. In order to control these movements, the precise location of the robotic mechanisms within the library relative to the data storage media and the read/write devices must be known. An example of such a system is a tape library. In this case, tape cartridges are stored in specific locations within a structure, and a robotic unit moves about the structure, transferring cartridges to and from tape drives where the information can be accessed by an external host.

Many of these automated cartridge systems are accessed through a network. The network client protocols for these automated cartridge systems are often proprietary and are not easy to develop, port, maintain, and extend. Currently, access to an automated cartridge system from a client location requires installation of software encompassing the proprietary protocol. Porting the protocols to different platforms to control these automated cartridge systems is difficult, especially in view of the many different types of platforms that have to be supported for different customers.

In many applications, the amount of data is large enough that multiple library storage modules are employed in which each module contains cell arrays and a robotic arm, but does not require additional host computers and does not contain a tape drive. These multiple library storage units are typically arranged adjacent to one another and pass-through ports are provided for passing tape cartridges from one library storage module to an adjacent library storage module. In these systems, a problem exists in automated library systems to facilitate loading and unloading of cartridges when the number of cartridges and drive devices are greater than some threshold of reasonable performance.

Within certain intelligence communities, there exist a number of separate networks carrying, for example, unclassified, secret and top secret data. The rules governing network security may be typically set by a government security agency, such as, for example, the National Security Agency (NSA) who, without exception may not allow any of the three networks to communicate with each other over known communication paths, such as, via electronic, fiber, firewalls and the like. The method data is transmitted presently is that a user creates two data cartridges, one of the data cartridges remains in its current environment and the second data cartridge may be hand carried to the next security level where it is catalogued into the security system and never returned to its origination point. Consequently, any data passing from one security level to the next higher security level is manual, which is inherently slow and costly considering the secure environments. In addition, any time a data cartridge is created and passed up to the next level of security, the site at which the cartridge is delivered ensures that the data cartridge is never inadvertently or otherwise returned to a lower security level. The logistics involved with manual handling and transportation of secure date is staggering.

In addition, a user faced with greater than sixteen library storage modules (LSMs) requires even more manual intervention. Presently, within some organizational frameworks, anyone wishing to share cartridges in multiple LSMs within an automated cartridge system (ACS) must have a shared control data set (CDS) in Automated Cartridge System Library Server(ACSLS) or a third party catalogue. Since a shared server may be required to connect to an unclassified and classified network, security personnel within security agencies may not authorize the server connection. Although firewalls may be installed in a local area network (LAN) connection, the security personnel still may not authorize the connection between the two networks. Even if there was the remotest possibility that the system could be compromised by allowing secret or top secret data to be transferred back to the unclassified system, security personnel would not authorize the connection between the unclassified and classified networks.

Therefore, any sharing of data must be accomplished without sharing the ACSLS or any type of LAN/WAN connections between the LSM. Additionally, if allowed, any such connections must only allow data to flow to a higher security level but not allow data to flow to a lower security level.

Therefore, it would be advantageous to have an improved method and apparatus for addressing security issues of transmission of data between an unclassified and classified network. It would also be advantageous to have an improved method and apparatus for allowing the expansion beyond sixteen library storage modules without major revisions to the host software component (HSC).

### SUMMARY OF THE INVENTION

The present invention provides secure gateway multiple automated data storage system sharing. Data is transmitted from a first data storage unit within a first automated data storage system to a second data storage unit. A request is then received from a second data storage system for the second data storage unit. The second data storage unit is then transported to the second data storage system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system is in which the present invention may be implemented;

FIG. 2 depicts a block diagram of a data processing system which may be implemented as a server, in accordance with the present invention;

FIG. 3 depicts a block diagram of a data processing system in which the present invention may be implemented;

FIG. 4 is a block diagram illustrating data flow paths used to transfer data between a primary storage system and a secondary storage system in accordance with a preferred embodiment of the present invention;

FIG. 5 is a block diagram of a mass storage system which operates with shared catalogues in accordance with a preferred embodiment of the present invention;

FIG. 6 is a block diagram of a mass storage system which operates with separate catalogues in accordance with a preferred embodiment of the present invention;

FIG. 7 is an exemplary flowchart illustrating a gateway pass through port (GPTP) in accordance with a preferred embodiment of the present invention;

FIG. 8 is an exemplary flowchart illustrating a source automatic cartridge system in accordance with a preferred embodiment of the present invention; and

FIG. 9 is an exemplary flowchart illustrating a destination automatic cartridge system in accordance with a preferred embodiment of the present invention.

### DETAILED DESCRIPTION OF THE PREFERRED EMBODIMENT

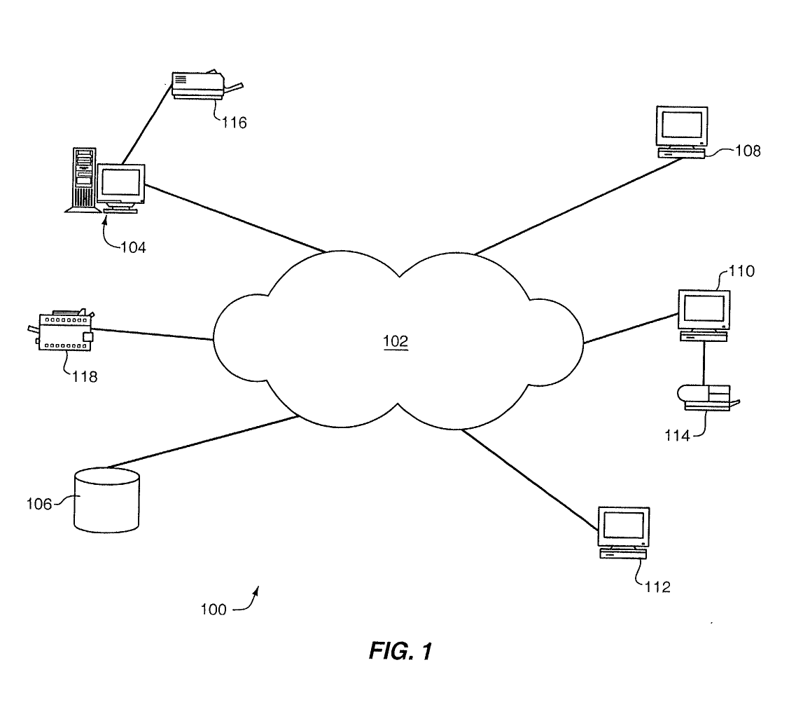

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections. In the depicted example, server 104 is connected to network 102, along with storage unit 106. In addition, clients 108, 110 and 112 are also connected to network 102. These clients, 108, 110 and 112, may be, for example, personal computers or network computers.

For purposes of this application, a network computer is any computer coupled to a network that receives a program or other application from another computer coupled to the network. In the depicted example, server 104 provides data, such as boot files, operating system images, data from databases or specific files used by applications, and executable modules of applications, to clients 108-112. Clients 108, 110 and 112 are clients to server 104. Distributed data processing system 100 may include additional servers, clients, and other devices not shown. Distributed data processing system 100 also includes printers 114, 116 and 118. A client, such as client 110, may print directly to printer 114. Clients such as client 108 and client 112 do not have directly attached printers. These clients may print to printer 116, which is attached to server 104, or to printer 118, which is a network printer that does not require connection to a computer for printing documents. Client 110, alternatively, may print to printer 116 or printer 118, depending on the printer type and the document requirements.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network. FIG. 1 is intended as an example and not as an architectural limitation for the processes of the present invention.

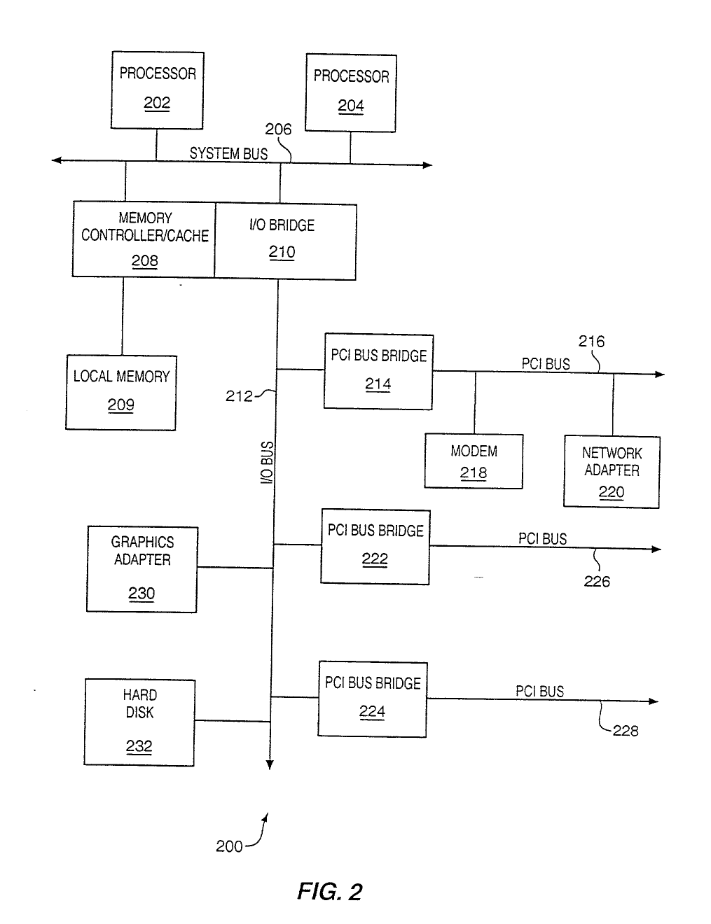

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support a specific number (often in the range of two to seven) of PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly. Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RS/6000, a product of International Business Machines Corporation in Armonk, N.Y., running the Advanced Interactive Executive (AIX) operating system.

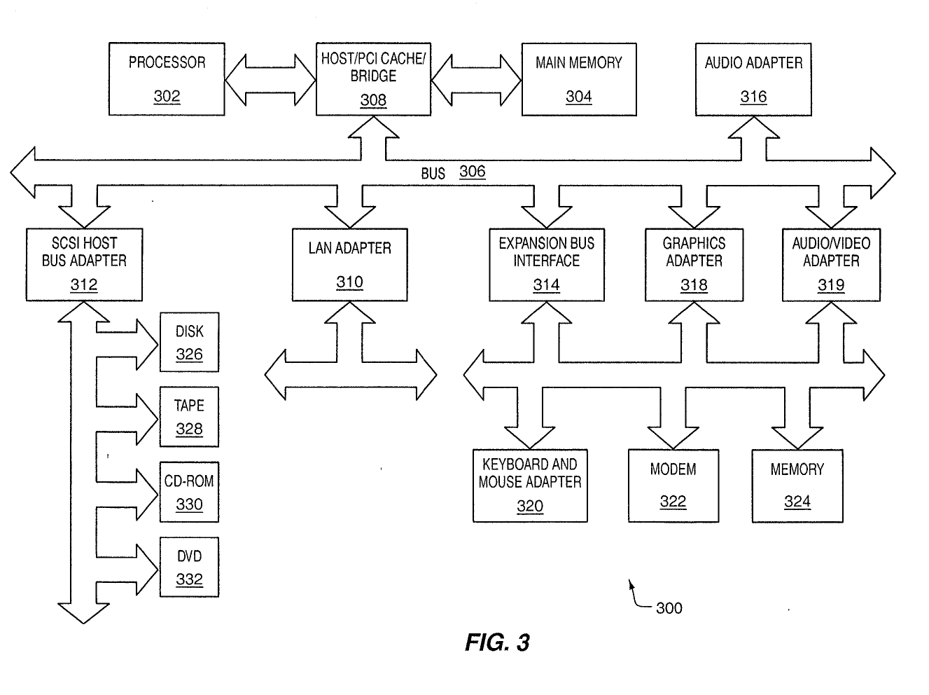

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302.

Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as AIX, which is available from International Business Machines Corporation. “AIX” is a trademark of International Business Machines Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

The present invention provides a secure data storage unit gateway system. In the following figures a tape cartridge data storage unit is described using a automated tape cartridge storage system. However, many modifications and variations will be apparent to those of ordinary skill in the art. For example, any type of data storage unit may be used in implementing the present invention, such as, for example, CD-ROMS, DVDs and the like.

In the following example, tape cartridges may be transferred from one automatic tape cartridge system to another automatic tape cartridge system. The automatic tape cartridge systems may have separate automated cartridge system library servers with no physical connection between them except, for example, a pass-through port. A user may create at least two tape cartridges in an unclassified library storage module silo. One of the tape cartridges remains in a first library storage module silo while a second tape cartridge is moved to an adjoining second classified library service module. This operation may be totally automatic. The unclassified library storage module places the second tape cartridge into a gateway pass-through port between the library storage modules. The second tape cartridge transferred to the classified library storage module receives the second tape cartridge through its gateway pass-through port. The second library storage module may then have the option of either mounting or shelving the tape cartridge.

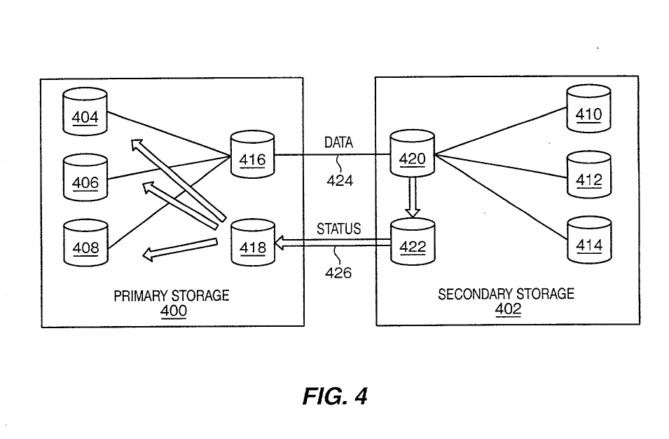

FIG. 4 depicts a block diagram illustrating data flow paths used to transfer data between a primary storage system and a secondary storage system is depicted in accordance with a preferred embodiment of the present invention. Primary storage system 400 sends data to secondary storage system 402 each time data is written to primary storage system by a data processing system, such as network 102 in FIG. 1. Primary storage 400 and secondary storage 402 may be implemented using a storage system, such as, for example, storage system 106 in FIG. 1.

Primary storage system 400 in this example includes a first set of volumes, volumes 404-408. Secondary storage system 402 includes a second set of volumes, volumes 410-414, which correspond to the first set of volumes in primary storage 400. The correspondence between the volumes in these two storage systems is set up in pairs, such that a volume in primary storage system 400 has a corresponding volume in secondary storage system 402 to form the pair. For example, volume 404 is paired with volume 410, volume 406 is paired with volume 412, and volume 408 is paired with volume 414.

Further, primary storage system 400 includes a primary data bridge 416 and a secondary status bridge 418. Secondary storage system 402 includes a secondary data bridge volume 420 and a primary status bridge volume 422. Volumes in each of the storage systems are designated for use in transferring data. As a result of this selection and configuration, primary data bridge volume 416, secondary status bridge volume 418, secondary data bridge volume 420, and primary status bridge volume 422 are reserved for internal use by the two storage systems 400 and 402.

With the bridge volumes defined, two paths, data bridge path 424 and status bridge path 426 are established between primary storage system 400 and secondary storage system 402. Data bridge path 424 begins at primary data bridge volume 416 in primary storage system 400 and ends at secondary data bridge volume 420 in secondary storage system 402. Status bridge path 426 begins at primary status bridge volume 422 in secondary storage system 402 and ends at secondary status bridge volume 418 in primary storage system 400. Data bridge path 424 is used to transfer data from primary data bridge volume 416 to secondary data bridge volume 420, while status bridge path 426 is used to transfer status information from primary status bridge volume 422 to secondary status bridge volume 418. Data written to volumes 404-408 are transferred to corresponding volumes 410-414. In the depicted examples, the data is in the form of tracks that are copied from a primary volume to a secondary volume.

Data from different volumes in primary storage 400 are queued at primary data bridge volume 416 and transferred to secondary data bridge volume 420. From secondary bridge volume 420, the data is relocated to the corresponding volume of the pair in secondary storage 402. This relocating step with virtual volumes involves converting and saving the data to the target volume. Converting means changing the track identifier from the bridge volume to the correct target volume. For example, data transferred from a volume, such as volume 404 to volume 410, is transferred using primary data bridge volume 416 and secondary data bridge volume 420. The data is transferred from volume 404 to primary data bridge volume 416. This data is then transferred using data bridge path 424 to secondary data bridge volume 420. When the data is received at secondary data bridge volume 420, the data is then converted and saved to volume 410. If data is to be transferred from volume 406 to volume 412, the same data path, data bridge path 424 may be used.

Status information is sent from volume 420 and queued on primary status bridge volume 422. After the status information is received on primary status bridge volume 422, status information is returned using status bridge path 426. No requirement is present for status information to be received confirming the writing of data to a secondary volume before data from a primary volume can be written to a corresponding secondary volume. In other words, the transfer of data and the return of status information may occur asynchronously.

In transferring tracks of data from a primary volume to a corresponding secondary volume, the target volume is identified such the data can be relocated to the correct volume once received at the secondary data bridge volume.

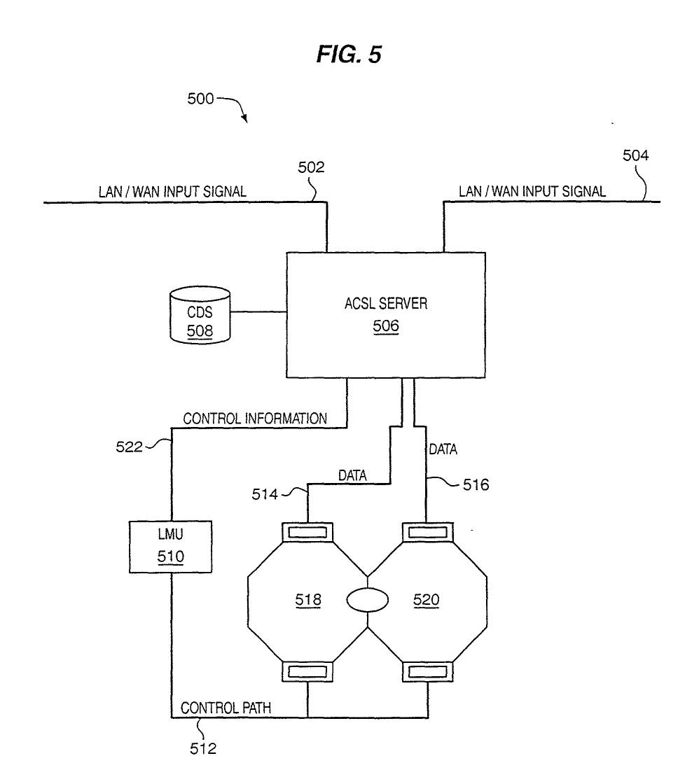

FIG. 5 is a block diagram of a mass storage system which operates with shared catalogues in accordance with a preferred embodiment of the present invention. Mass storage system represents the current framework in which cartridges are shared. Sharing cartridges in multiples library storage modules (LSMs) within an automatic cartridge system (ACS) has a shared control data set in an automated cartridge system library server (ACSLS) or a third party catalogue.

In this example, mass storage system 500 is an exemplary automated cartridge system (ACS). The ACS is designed to operate with an IBM or IBM-compatible host computer capable of communication with a conventional 327X-type terminal controller. Comprised generally of a library management unit (LMU) 510 and a library storage modules (LSM) 518 and 520, mass storage system 500, through its associated host software component (HSC), enables storage and retrieval of magnetic tape cartridges for use by a host computer across a conventional channel. LMU 510 serves as the library controller and provides the interface between from one to sixteen host computers and up to 16 LSMs.

Mass storage system 500 consists of LAN/WAN input signal 502 and LAN/WAN input signal 504 providing input into automated cartridge system library server 506. Connected to ACSLS 506 is data control set (CDS) 508. As input signals 502 and 504 are received by automated cartridge system library server 506, automated cartridge system library server 506 updates control data set 508. When a cartridge is requested by a host, automated cartridge system library server 506 searches the catalogue which may be maintained on control data set 508. Automated cartridge system library server 506 may determine the tape cartridge system location in the library row slot and then may instruct a robot (not shown) to fetch the tape cartridge and transport the tape cartridge to an assigned location, such as, for example a tape drive, a pass-through port and the like. ACSLS 506 separates input signals 502 and 504 into control information signal 522 and data signals 514 and 516. Control information signal 522 is sent to library management unit 510. Library process control information 522 and transmits the processed control information 522 via control path 512 to library service modules 518 and 520. Library management unit 510 instructs the robot to move a tape cartridge from a first location to a second location. Library management unit 510 may be a TCP/IP protocol. Control information 522 is used to instruct the robot to transport a cartridge from a first location to a second location. In addition, the robot may be constantly updating control data set 508 as to the status of every robotic movement. This updating is done in the event of a power outage and therefore the robot would have up to date information as to the status of every tape cartridge in transit.

In addition, data signal 514 and data signal 516 are transmitted from ACSLS 506 to LSMs 518 and 520. Data signals 514 and 516 may be transmitted over the same path but are independent of each other. There may be two signals. The first is control information signal 522 and data transfer signals 514 and 516. Data signals 514 and 516 may only carry user data. Both control information 522 and data signals 514 and 516 may be transmitted over a WAN/LAN connection. However, ACSL server 506 separates LAN/WAN input signal 502 into control information signal 522 and data signals 514 and 516.

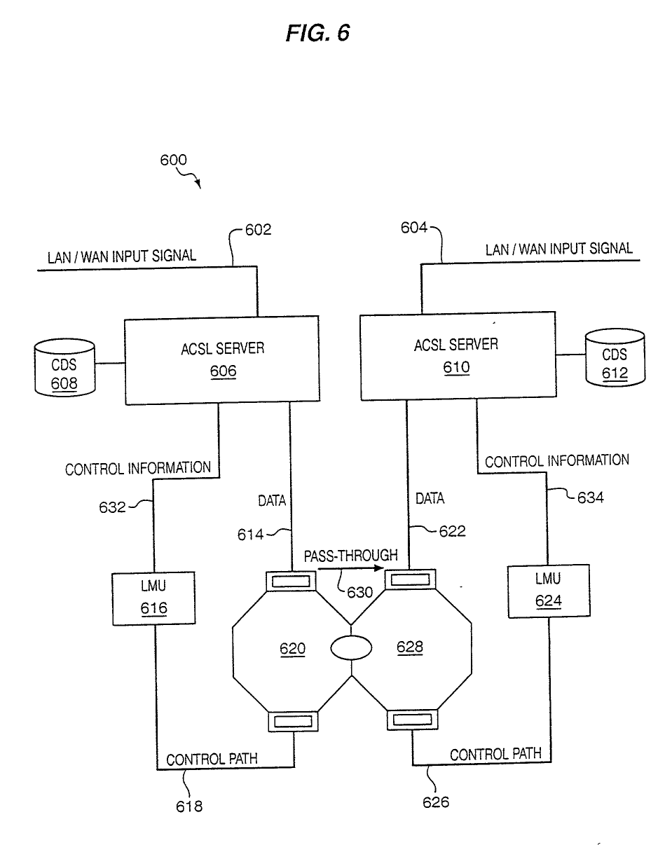

FIG. 6 is a block diagram of a mass storage system which operates with separate catalogues in accordance with a preferred embodiment of the present invention. In this example, LAN/WAN input signal 602 is input into ACSLS 606 while LAN/WAN input signal 604 is input into ACSLS 610. In addition, both ACSLS 606 and ACSLS 610 have dedicated control data sets 608 and 612, respectively. ACSLS 606 and 608 receive their input signals and provide separate and discrete control information signals and data signals. For example, ACSLS 606 receives LAN/WAN input signal 602, splits LAN/WAN input signal 602 into control information signal 632, which is transmitted to LMU 616, and data signal 614. LMU 616 processes control information signal 632 and outputs processed control information signal 632 via control path 618. Both processed control signal 632 and data 614 originating from LAN/WAN input signal 602 are input into LMU 620. Likewise, ACSLS 610 receives LAN/WAN input signal 604, splits LAN/WAN input signal 604 into control information signal 634, which is transmitted to LMU 624, and data signal 622. LMU 624 processes control information signal 634 and outputs processed control information signal 634 via control path 626. Both processed control signal 634 and data 622 originating from LAN/WAN input signal 604 are input into LMU 628.

In this example, pass-through port 630 is designed to transport tape cartridges from library service module 620 to library service module 628 in either direction. Pass-through port 630 may be used when a tape cartridge is in a library service module, such as, for example, library service module 620 or 628 when all tape drives are in use. ACSL server 606 or 610 may look for the closest available tape drive and initiate a pass-through command to a targeted library service module and a tape drive.

A pass-through port may be manufactured in three sections (not shown) which may include a master receiver tower, a draw bar arm assembly and a slave receiver tower. The master receiver tower is called the master since it supplies power to the entire pass-through port assembly.

Tape cartridge movement may be as follows. The robot places a pass-through port cartridge in the master receiver tower. Once in the master receiver tower, the tape cartridge slides down a drop ramp onto a draw bar path located on the draw bar arm. The draw bar arm transports the tape cartridge along the draw bar path where it encounters a tumble block which rotates the tape cartridge, for example, 180 degrees, so that the tape cartridge is properly oriented for a receiving robot. At this point, the receiving robot is notified that a cartridge needs to be removed from a “GET” port. The GET port is located at the end of the draw bar path of the targeted tape cartridge. The GET port is where the robot fetches the tape cartridge from the pass-through port. For the present invention implementing a secure gateway, only the master receiver tower and the draw bar arm may be needed. Therefore, by eliminating the slave receiver tower it may be ensured that a tape cartridge is never sent back to the sending library service module.

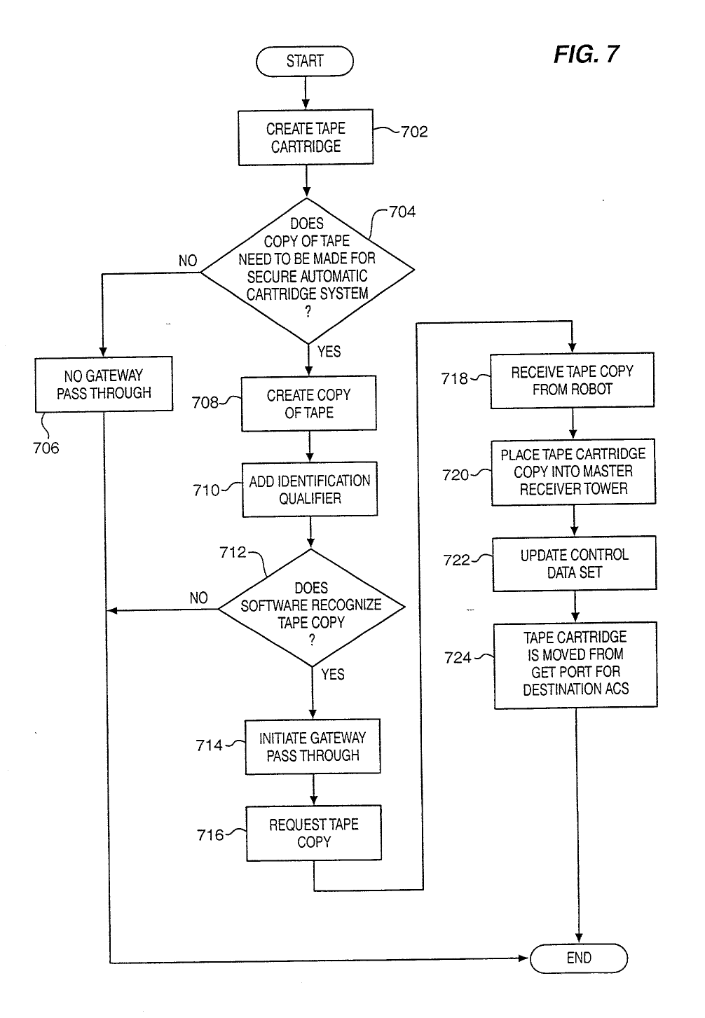

FIG. 7 is an exemplary flowchart illustrating a gateway pass through port (GPTP) in accordance with a preferred embodiment of the present invention. In this example, the operation starts by creating a tape cartridge (step 702). Then a determination is made as to whether or not a copy of the tape is needed for a secure automatic cartridge system (step 704). If a copy of the tape is not needed for a secure automatic cartridge system (step 704:NO), there will be no gateway pass-through performed (step 706) and thereafter the operation terminates. If a copy of the tape is needed for a secure automatic cartridge system (step 704:YES), a copy of the tape is created (step 708). An identification qualifier is added to the copy of the tape (step 710). An identification qualifier may be, for example, a copy serial number range or a separate serial number range. Then a determination is made as to whether or not the software recognizes the tape copy (step 712). The software may be invoked to handle the move request. If the software does not recognize the tape copy (step 712:NO), the operation terminates. If the software does recognize the tape copy (step 712:YES), the gateway pass-through is initiated (step 714).

Then a request is made for a copy of the tape by the software (step 716). The tape cartridge is then received from the robot (step 718). The tape cartridge copy is then placed into the Master Receiver Tower (step 720). The control data set is then updated (step 722). The control data set may be part of the ACSL server disk or may be external to the ACSL server. The control data set is a catalogue of every movement of tape cartridges in the library service module. The control data set may be created and managed by the ACSL server. The tape cartridge is then moved from a GET port for the destination ACS (step 724) and thereafter the operation terminates.

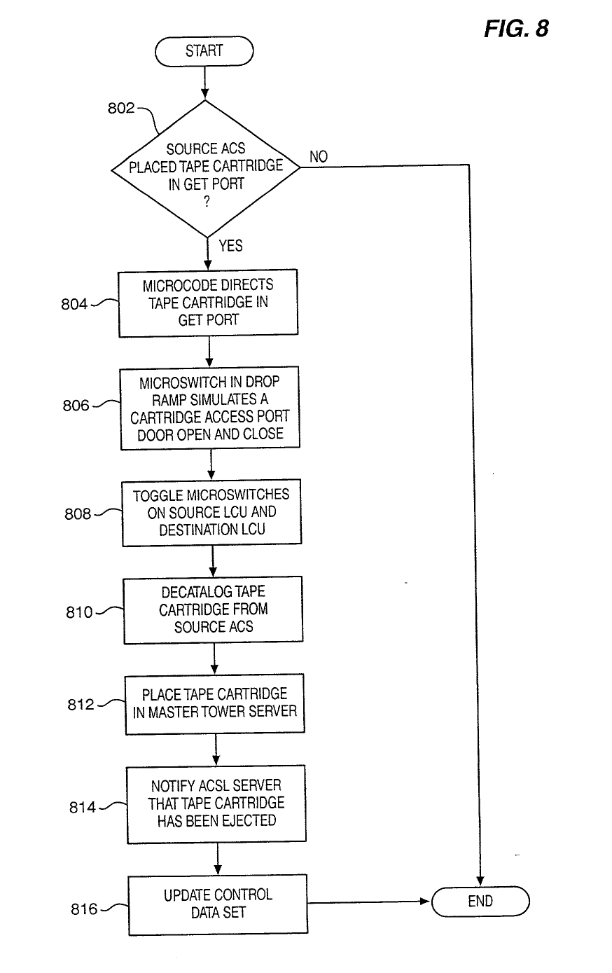

FIG. 8 is an exemplary flowchart illustrating a source automatic cartridge system in accordance with a preferred embodiment of the present invention. In this example, the operation begins with a determination as to whether or not the source ACS places the tape cartridge into the GET port (step 802). If the source ACS does not place the tape cartridge into the GET port (step 802:NO), the operation terminates. If the source ACS does place the tape cartridge into the GET port (step 802:YES), the microcode directs the tape cartridge in the GET port (step 804). The microcode may be resident in the library control unit. A microswitch in a drop ramp may simulate a cartridge access port door open and close (step 806). A mounting plate may contain at least two microswitches that are mounted in the tape cartridge path such that when the tape cartridge reaches the GET port the microswitches toggle (step 808). One microswitch is connected to a source LCU and the other microswitch is connected to a destination LCU. The tape cartridge is then decatalogued from the source ACS (step 810). Once the cartridge is placed in the Master Tower Server (step 812), the ACSL server is notified that the tape cartridge has been ejected (step 814). The control data set is then updated to reflect that the tape cartridge has been ejected (step 816) and thereafter the operation terminates.

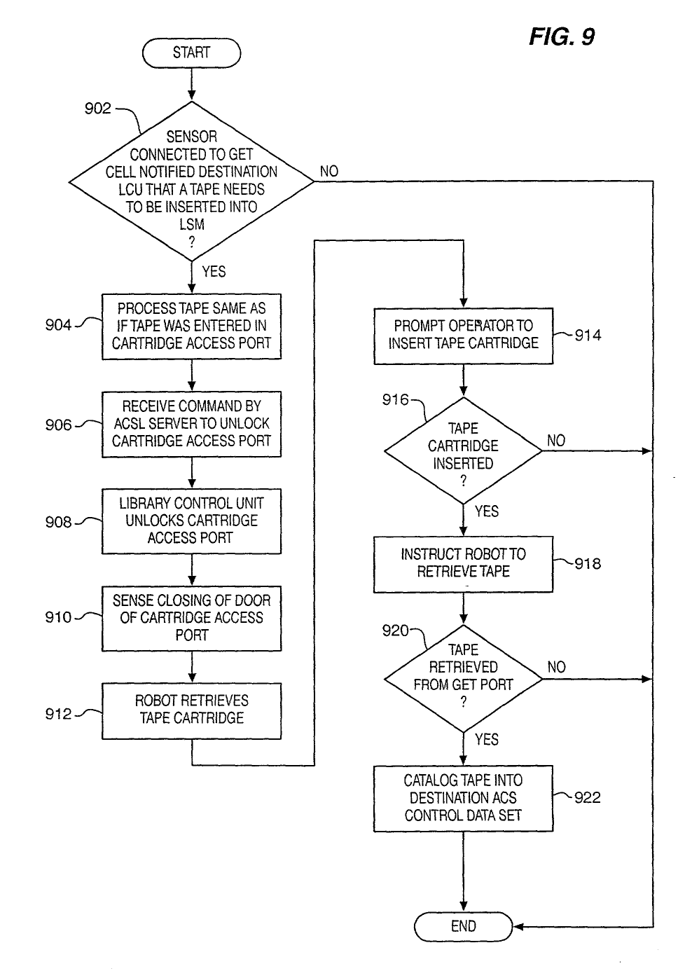

FIG. 9 is an exemplary flowchart illustrating a destination automatic cartridge system in accordance with a preferred embodiment of the present invention. In this example, a determination is made as to whether or not a sensor connected to the GET cell has notified the destination LCU that a tape cartridge needs to be inserted into the LSM (step 902). The sensor may be a microswitch that is tripped when the tape cartridge is moved into the GET port. If the sensor connected to the GET cell has not notified the destination LCU that a tape cartridge needs to be inserted into the LSM (step 902:NO), the operation terminates. If the sensor connected to the GET cell has notified the destination LCU that a tape cartridge needs to be inserted into the LSM (step 902:YES), the tape cartridge is processed the same as if a tape cartridge was entered into a cartridge access port (step 904). To transfer a tape cartridge into the library service module, an operator may enter a command to the ACSL server via a master terminal to unlock the cartridge access port (step 906). When the tape cartridge is moved to the cartridge access port, a library control unit unlocks the cartridge access port (step 908). When a door to the cartridge access port is closed, the library control unit senses the closing of the door to the cartridge access port (step 910) and this initiates the robot to retrieve the tape cartridge (step 912).

Then an operator is prompted to insert a tape cartridge (step 914). The ACSL server may prompt an operator to either mount the tape cartridge in a tape drive or catalogue the tape cartridge into the library service module for future reference. The insertion point is the GET port for the secure gateway. Then a determination is made as to whether or not the tape cartridge is inserted (step 916). If the tape cartridge is not inserted (step 916:NO), the operation terminates.

If the tape cartridge is inserted (step 916:YES), the robot is instructed to retrieve the tape cartridge (step 918). Then a determination is made as to whether or not the tape cartridge is retrieved from the GET port (step 920). If the tape cartridge is not retrieved from the GET port (step 920:NO), the operation terminates. If the tape cartridge is retrieved from the GET port (step 920:YES), the tape cartridge is catalogued into the destination ACS control data set (step 922) and thereafter the operation terminates.

Therefore, the present invention provides an improved method and apparatus for an addressing security issues of transmission of data between an unclassified and classified network. The present invention also provides an improved method and apparatus for allowing the expansion beyond sixteen library storage modules without major revisions to the host software component (HSC).

The description of the present invention has been presented for purposes of illustration and description, but is not intended to be exhaustive or limited to the invention in the form disclosed. Many modifications and variations will be apparent to those of ordinary skill in the art. For example, transferring tape cartridges from one automated tape cartridge system to another automated tape cartridge system was described. However, any type of data storage unit may be used in implementing the present invention, such as, for example, CD-ROMS, DVDs and the like. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a secure gateway for sharing a multiple gateway automated data storage system containing a first data storage unit with data stored within the first data storage unit, comprising the steps of:
transmitting the data from the first data storage unit within a first automated data storage system to a second data storage unit;
receiving a request from a second data storage system for the second data storage unit; and
transporting the second data storage unit to the second data storage system.

2. The method of claim 1, further comprising:
generating a identification qualifier for the second data storage unit.

3. The method of claim 1, wherein the first automated data storage system is a source automated data storage system.

4. The method of claim 3, wherein the source data storage system is an unclassified data storage system.

5. The method of claim 1, wherein the second data storage system is a destination automated data storage system.

6. The method of claim 5, wherein the destination data storage system is a classified destination data storage system.

7. The method of claim 1, further comprising:
updating a control data set managed by an automated library data storage system library server.

8. The method of claim 7, wherein the control data set is integrated into the automated data storage system library server.

9. The method of claim 7, wherein the control data set is external to the automated data storage system library server.

10. The method of claim 7, wherein updating the control data set comprises:
decataloging the second data storage unit from the first automated data storage system; and
notifying the automated library data storage system library server that the second data storage unit has been removed from the first automated data storage system.

11. The method of claim 7, wherein updating the control data set comprises:
cataloging the second data storage unit into the second automated data storage system; and
notifying the automated library data storage system library server that the second data storage unit has been received at the second automated data storage system.

12. The method of claim 1, wherein transporting the second data storage unit to the second data storage system further comprises:
controlling movement of a robot within an automated library data storage system library server.

13. The method of claim 1, wherein the multiple gateway automated data storage system comprises at least two automated data storage systems.

14. A system in a secure gateway for sharing a multiple gateway automated data storage system containing a first data storage unit with data stored within the first data storage unit, comprising:
transmitting means for transmitting the data from the first data storage unit within a first automated data storage system to a second data storage unit;
receiving means for receiving a request from a second data storage system for the second data storage unit; and
transporting means for transporting the second data storage unit to the second data storage system.

15. The system of claim 14, further comprising:
generating means for generating a identification qualifier for the second data storage unit.

16. The system of claim 14, wherein the first automated data storage system is a source automated data storage system.

17. The system of claim 16, wherein the source data storage system is an unclassified data storage system.

18. The system of claim 14, wherein the second data storage system is a destination automated data storage system.

19. The system of claim 18, wherein the destination data storage system is a classified destination data storage system.

20. The system of claim 14, further comprising:
updating means for updating a control data set managed by an automated library data storage system library server.

21. The system of claim 20, wherein the control data set is integrated into the automated data storage system library server.

22. The system of claim 20, wherein the control data set is external to the automated data storage system library server.

23. The system of claim 14, wherein the updating means for updating the control data set comprises:
decataloging means for decataloging the second data storage unit from the first automated data storage system; and
notifying means for notifying the automated library data storage system library server that the second data storage unit has been removed from the first automated data storage system.

24. The system of claim 14, wherein the updating means for updating the control data set comprises:
cataloging means for cataloging the second data storage unit into the second automated data storage system; and
notifying means for notifying the automated library data storage system library server that the second data storage unit has been received at the second automated data storage system.

25. The system of claim 14, wherein the transporting means for transporting the second data storage unit to the second data storage system further comprises:
controlling means for controlling movement of a robot within an automated library data storage system library server.

26. The system of claim 14, wherein the multiple gateway automated data storage system comprises at least two automated data storage systems.

27. A computer program product in a computer readable medium for sharing a multiple gateway automated data storage system containing a first data storage unit with data stored within the first data storage unit, comprising:
first instructions for transmitting the data from the first data storage unit within a first automated data storage system to a second data storage unit;
second instructions for receiving a request from a second data storage system for the second data storage unit; and
third instructions for transporting the second data storage unit to the second data storage system.

28. The computer program product of claim 27, further comprising:
fourth instructions for generating a identification qualifier for the second data storage unit.

29. The computer program product of claim 27, further comprising:
fifth instructions for updating a control data set managed by an automated library data storage system library server.

30. A secure gateway apparatus for sharing a multiple gateway automated data storage system, the apparatus comprising:
a controller that controls transporting a data storage unit from a first data storage device to a second data storage device; and
a transportation device that transports the data storage unit from the first data storage device to the second data storage device, wherein the transportation device protects against transporting the data storage unit from the second data storage device back to the first data storage device.
